(19) United States
(12) Patent Application Publication
(10) Pub. No.: US 2026/0268171 A1
(43) Pub. Date: Sep. 10, 2026

(54) METHOD FOR OPTIMIZING AMMONIA INJECTION CONTROL OF DENITRIFICATION SYSTEM IN THERMAL POWER PLANTS CONSIDERING THE CHARACTERISTICS OF INCOMING COAL

(71) Applicant: DATANG ENVIRONMENT INDUSTRY GROUP CO., LTD., Beijing (CN)

(72) Inventors: Lei MENG, Beijing (CN); Yuyong BAI, Beijing (CN); Yan YANG, Beijing (CN); Liming ZHU, Beijing (CN); Lijian LI, Beijing (CN); Guoqing ZHAO, Beijing (CN); Xiaoman TIAN, Beijing (CN); Jialiang WANG, Beijing (CN); Shuang XIA, Beijing (CN); Mingsheng DU, Beijing (CN); Siwei PENG, Beijing (CN); Wu MA, Beijing (CN); Xiaoyue MA, Beijing (CN); Yang GAO, Beijing (CN); Ziyi SONG, Beijing (CN); Fei LI, Beijing (CN)

(73) Assignee: DATANG ENVIRONMENT INDUSTRY GROUP CO., LTD., Beijing (CN)

(21) Appl. No.: 19/120,190

(22) PCT Filed: Jan. 21, 2025
(86) PCT No.: PCT/CN2025/073602

§ 371 Date: Apr. 10, 2025

(30) Foreign Application Priority Data
Dec. 30, 2024 (CN) 202411972353.8

(51) Int. Cl. G06N 5/022; B01D 53/34; B01D 53/56

(52) U.S. Cl. CPC G06N 5/022; B01D 53/346; B01D 53/56; B01D 2251/2062; B01D 2257/404; B01D 2258/0283

(57) ABSTRACT

The present disclosure provides a method for ammonia injection control of a denitrification system in thermal power plants considering the characteristics of incoming coal. A total amount ammonia injection control method for denitrification mainly employs a two-stage intelligent controller. A main-intelligent controller controls the total amount of ammonia injection based on the deviation value of the outlet NOx concentration, as well as the feedforward values of the denitrification inlet NOx concentration and the flue gas volume. A sub-intelligent controller for the total amount controls the opening degree of the total valve according to the deviation value of the amount of ammonia injection. The zonal control method for denitrification ammonia injection volume takes the deviation value of the outlet NOx concentration of each zone and the total ammonia injection volume as constraint condition to obtain the opening degree of the regulating valve in each zone.

### CROSS-REFERENCE TO RELATED PATENT APPLICATIONS

This application claims a priority from the Chinese Patent Application No. 202411972353.8, filed with the Chinese Patent Office on Dec. 30, 2024, entitled “METHOD FOR OPTIMIZING AMMONIA INJECTION CONTROL OF DENITRIFICATION SYSTEM IN THERMAL POWER PLANTS CONSIDERING THE CHARACTERISTICS OF INCOMING COAL”, content of which is incorporated herein by reference in its entirety.

### FIELD OF THE INVENTION

The disclosure relates to the technical field of flue gas denitrification in coal-fired power plants, and in particular to a method for optimizing ammonia injection control of a denitrification system in thermal power plants considering the characteristics of incoming coal.

### BACKGROUND OF THE INVENTION

After the ultra-low emission transformation of flue gas in power plants, it is required that the NOx emission concentration of coal-fired power plants must be lower than 50 mg/m³. At present, the most commonly used denitrification technology at home and abroad is the SCR (Selective Catalytic Reduction) flue gas denitrification technology, in which the control of ammonia injection volume is an important process. When the ammonia injection volume is too small, the NOx emission at the outlet will exceed the standard. When the ammonia injection volume is excessive, the ammonia escape rate will increase, causing blockage and corrosion of the downstream air preheater. Therefore, the control of ammonia volume is crucial for the denitrification system.

Currently, the commonly used method is the total ammonia injection control method, which often adopts a single-loop fixed-value control method for the outlet NOx, a fixed molar ratio control method or a cascade PID control method. However, the control process of the above-mentioned methods has a certain lag and the control effect is poor. At the same time, due to the non-uniformity of the flow field in the denitrification system itself, the measurement of NOx at a single denitrification outlet often cannot represent the characteristics of the entire system. As a result, the control effect is poor, and sometimes the NOx emission concentration exceeds 50 mg/m³.

Therefore, in order to achieve the economic and environmental protection goals for the NOx concentration at the outlet of the denitrification reactor, the appropriate adjustment of the total ammonia injection volume and the uniformity of ammonia injection are issues that need to be urgently addressed in the current denitrification field.

### SUMMARY OF THE INVENTION

The purpose of the present disclosure is to provide a method for optimizing ammonia injection control of a denitrification system in thermal power plants considering the characteristics of incoming coal. This method can achieve the standard discharge of the outlet NOx concentration of the denitrification reactor under the condition of the minimum ammonia injection volume, which is of great significance for reducing the emission of pollutants and costs in thermal power plants.

According to the purpose of the present disclosure, the present disclosure provides a method for optimizing ammonia injection control of a denitrification system in thermal power plants considering the characteristics of incoming coal, including a total control method for the amount of denitrification ammonia injection, a zonal control method for the amount of denitrification ammonia injection, and a construction of total amount control and zonal control parameters under different coal quality characteristics, in which the method includes the following steps:
step 100, by means of the total control method for the amount of denitrification ammonia injection, mainly adopting a two-stage intelligent controller for control, in which a main-intelligent controller controls the total amount of the ammonia injection based on the deviation value of the outlet NOx concentration, as well as the feedforward values of the denitrification inlet NOx concentration and the flue gas volume, and a sub-intelligent controller for the total amount controls the opening degree of the total valve according to the deviation value of the amount of ammonia injection;
step 200, by means of the zonal control method for denitrification ammonia injection volume, taking the deviation value of the outlet NOx concentration of each zone and the total ammonia injection volume as constraint condition to obtain the opening degree of the regulating valve in each zone; and
step 300, by means of the construction of the parameters for total amount control and zonal control under different coal quality characteristics, mainly based on the differences in the ash content, volatile matter content, moisture content, and calorific value of the coal entering the thermal power plants, establishing the parameter values of each value of controllers.

Furthermore, the input of the main-intelligent controller for the total amount is mainly the deviation between the set value of the outlet NOx concentration and the average value of the measured outlet NOx concentration of each zone. The output of the main-intelligent controller for the total amount is mainly the calculated value of the ammonia injection volume. The input of the sub-intelligent controller for the total amount is the calculated value of the ammonia injection volume and theoretical ammonia injection volume. The output of the sub-intelligent controller for the total amount is the total control valve of the denitrification reactor. The total ammonia injection amount is controlled by the opening degree of the total control valve, thereby controlling the outlet NOx concentration of the denitrification reactor.

Furthermore, the main-intelligent controller for the total amount and the sub-intelligent controller for the total amount adopt PID control or model predictive control, and their parameters are optimized by genetic algorithm. The zonal-intelligent controller adopts PID control or model predictive control, and its parameters are optimized by genetic algorithm.

Furthermore, the zonal control method for denitrification ammonia injection adopts a zonal-intelligent controller, the input of the zonal-intelligent controller is the deviation between the average value of the outlet NOx concentration measurement of each zone and the measured value of the outlet NOx concentration of each zone, and the output of the zonal-intelligent controller is the calculated value of the ammonia injection volume of each zone. The opening degree of the control valve of each zone is obtained according to the calculated value of the ammonia injection volume of each zone and the amount of theoretically required ammonia injection of each zone, so as to control the ammonia injection volume of each zone, and further control the outlet NOx concentration value of each zone.

Furthermore, in step 300, different incoming coals are determined according to the parameters of ash content, volatile matter content, moisture content, and calorific value parameter of the incoming coals. Under different incoming coals, the parameters of the inlet NOx concentration of the denitrification reactor, the flue gas volume, the main-intelligent controller for the total amount, the sub-intelligent controller for the total amount, and the zonal-intelligent controller are different. According to different incoming coals, the parameters of the above-mentioned models are established, and a parameter library for different incoming coals is constructed. In the subsequent control process, according to the opacity of incoming coal, different model parameters are selected from the parameter library for incoming coal.

Furthermore, the theoretical ammonia injection volume is mainly obtained based on the product of the SCR inlet NOx concentration value, the flue gas volume and the ammonia nitrogen molar ratio.

Furthermore, the SCR inlet NOx concentration is mainly predicted based on a BP neural network algorithm. The influencing factors related to the inlet NOx concentration are analyzed according to the generation mechanism of the SCR inlet NOx concentration, including unit load, total air volume, total coal volume, and primary air volume. These parameters are used as the input parameters of the BP neural network, and the output is the SCR inlet NOx concentration.

Furthermore, the flue gas volume is predicted according to the BP neural network algorithm. The influencing factors related to the flue gas volume are analyzed according to the flue gas generation mechanism, including unit load, total air volume, and oxygen content. These parameters are used as input parameters of the BP neural network, and the output is the flue gas volume.

Furthermore, the BP neural network adopts a three-layer structure consisting of an input layer, a hidden layer and an output layer, and its parameters include the weights and thresholds between the input layer and the hidden layer, and the weights and threshold parameters between the hidden layer and the output layer. These parameters are mainly obtained by continuously optimizing the error function between the predicted values and the measured values.

Furthermore, the average of the outlet NOx concentration measurement of each zone is calculated according to formula (1):

$$Ave\_NOx = ( A1\_NOx + A2\_NOx + … + An\_NOx ) / n ; \qquad Formula ( 1 )$$

where A1_NOx, A2_NOx, and An_NOx are the outlet NOx concentration values of the 1st zone, the 2nd zone, and the nth zone, respectively, n is the number of zones.

Furthermore, the theoretical ammonia injection volume required for each zone is mainly obtained based on the total ammonia injection volume and the weight of each zone. The weight of each zone is mainly obtained based on the proportion of the outlet NOx concentration of each zone, which is specifically obtained according to formula (2):

$${λ}_{i} = \frac{Ai\_NOx}{A1\_NOx + A2\_NOx + … + An\_NOx} ; \qquad Formula ( 2 )$$

where Ai_NOx is the outlet NOx concentration of the ith zone, and λᵢ is the weight of the ith zone.

The amount of theoretically required ammonia injection for the ith zone is calculated according to formula (3):

$$Ai\_NH3 = {λ}_{i} * Total\_NH3 ; \qquad Formula ( 3 )$$

where Ai_NH3 is the theoretically required ammonia injection volume in the ith zone, and Total_NH3 is the total ammonia injection volume.

The technical solution of the present disclosure can predict the outlet NOx concentration and flue gas volume of the SCR reactor in advance, and solve the problems of large lag and inaccurate measurement existing in the measurement of built-in instruments and equipment. During the establishment of the intelligent controller, the differences in data characteristics under various loads are comprehensively considered. The genetic algorithm is used to optimize the parameters of different loads to obtain the optimal controller parameters. It can effectively control the outlet NOx concentration values of each zone, make the outlet NOx concentration of each zone evenly distributed, which is more conducive to total volume control. In the modeling process, the controller parameter values under different coal quality characteristics are also constructed. The system can adjust different parameters according to the different incoming coal, resulting in better control effect. It can keep the outlet NOx concentration value stable near the set value. The whole process is simple to operate and quick to adjust, achieving the goal of controlling the outlet NOx to meet the emission standards with the optimal ammonia injection volume.

### BRIEF DESCRIPTION OF THE DRAWINGS

In order to explain the embodiments of the present invention or the technical solutions in the prior art more clearly, the drawings needed to be used in the description of the embodiments or the prior art will be briefly introduced below. Obviously, the drawings in the following description are only some embodiments of the present invention. For those of ordinary skill in the art, other drawings can be obtained based on these drawings without creative labor.

FIG. 1 is a flow chart of a method for optimizing ammonia injection control according to an embodiment of the present disclosure;

FIG. 2 is a flow chart of a total amount ammonia injection control method for denitrification according to an embodiment of the present disclosure; and

FIG. 3 is a flow chart of a zonal control method for denitrification ammonia injection volume according to an embodiment of the present disclosure.

### DETAILED DESCRIPTION OF THE INVENTION

The technical solutions in the embodiments of the present invention will be clearly and completely described below with reference to the accompanying drawings in the embodiments of the present invention. Obviously, the described embodiments are only some of the embodiments of the present invention, rather than all the embodiments. Based on the embodiments of the present invention, all other embodiments obtained by those of ordinary skill in the art without creative labor fall within the scope of protection of the present invention.

In the description of the present invention, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise” and the like indicate orientations or positional relationships based on the orientations or positional relationships shown in the accompanying drawings, and are only for the convenience of describing the present invention and simplifying the description, and do not indicate or imply that the referred device or element must have a specific orientation, be constructed and operated in a specific orientation, and therefore should not be understood as limiting the present invention.

In addition, the terms “first” and “second” are only used for descriptive purposes and cannot be understood as indicating or implying relative importance or implicitly indicating the number of technical features indicated. Therefore, the features defined as “first” and “second” may explicitly or implicitly include one or more of the features. In the description of the present invention, “multiple” means two or more, unless otherwise clearly and specifically defined. In addition, the terms “installed”, “connected” and “connection” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal connection of two components. For those of ordinary skill in the art, the specific meanings of the above terms in the present invention can be understood according to specific circumstances.

### Embodiment 1

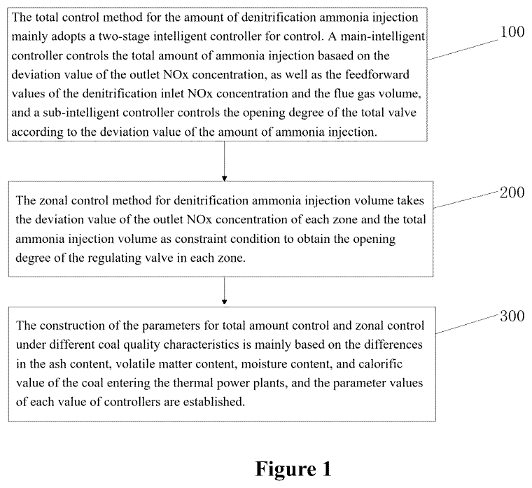

As shown in FIG. 1, a method for optimizing ammonia injection control of a denitrification system in thermal power plants includes a total control method for the amount of denitrification ammonia injection, a zonal control method for the amount of denitrification ammonia injection, and a construction of total amount control and zonal control parameters under different coal quality characteristics.

Specifically, the method includes the following steps.

At step 100, the total control method for the amount of denitrification ammonia injection mainly adopts a two-stage intelligent controller for control. A main-intelligent controller controls the total amount of ammonia injection based on the deviation value of the outlet NOx concentration, as well as the feedforward values of the denitrification inlet NOx concentration and the flue gas volume, and a sub-intelligent controller controls the opening degree of the total valve according to the deviation value of the amount of ammonia injection.

At step 200, the zonal control method for denitrification ammonia injection volume takes the deviation value of the outlet NOx concentration of each zone and the total ammonia injection volume as constraint condition to obtain the opening degree of the regulating valve in each zone.

At step 300, the construction of the parameters for total amount control and zonal control under different coal quality characteristics is mainly based on the differences in the ash content, volatile matter content, moisture content, and calorific value of the coal entering the thermal power plants, and the parameter values of each value of controllers are established.

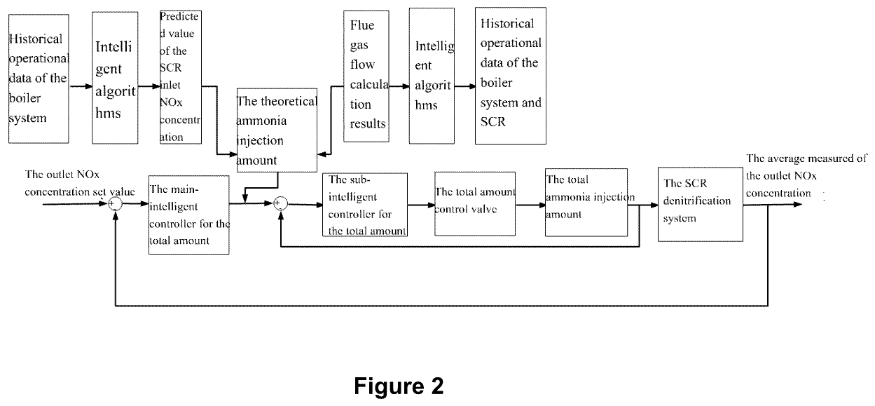

As shown in FIG. 2, the input of the main-intelligent controller for the total amount is mainly the deviation between the outlet NOx concentration set value and the average value of the measured value of the outlet NOx concentration of each zone. The output of the main-intelligent controller for the total amount is mainly the calculated value of the ammonia injection volume.

Specifically, the input of the sub-intelligent controller for the total amount is mainly the calculated value of the ammonia injection volume and theoretical ammonia injection volume. The output of the sub-intelligent controller for the total amount is the control valve of the denitrification reactor. The total amount of ammonia injection amount is controlled by the opening degree of the total amount control valve, thereby controlling the outlet NOx concentration of the denitrification reactor.

Specifically, the main-intelligent controller for the total amount and the sub-intelligent controller for the total amount adopt PID control or model predictive control, and their parameters are optimized by genetic algorithm.

Specifically, the theoretical ammonia injection volume is mainly obtained based on the product of the SCR inlet NOx concentration value, the flue gas volume and the ammonia nitrogen molar ratio.

Specifically, the SCR inlet NOx concentration is mainly predicted based on a BP neural network algorithm. Based on the generation mechanism of the SCR inlet NOx concentration, the influencing factors related to the inlet NOx concentration are analyzed, including unit load, total air volume, total coal volume, and primary air volume. These parameters are used as input parameters of the BP neural network, and the output is the SCR inlet NOx concentration.

Specifically, the flue gas volume is also predicted according to the BP neural network algorithm. The influencing factors related to the flue gas volume are analyzed according to the flue gas generation mechanism, including unit load, total air volume, and oxygen content. These parameters are used as input parameters of the BP neural network, and the output is the flue gas volume.

Specifically, the BP neural network adopts a three-layer structure consisting of an input layer, a hidden layer and an output layer, and its parameters include weights and thresholds between the input layer and the hidden layer, as well as weights and threshold parameters between the hidden layer and the output layer. These parameters are mainly obtained by continuously optimizing the error function between the predicted values and the measured values.

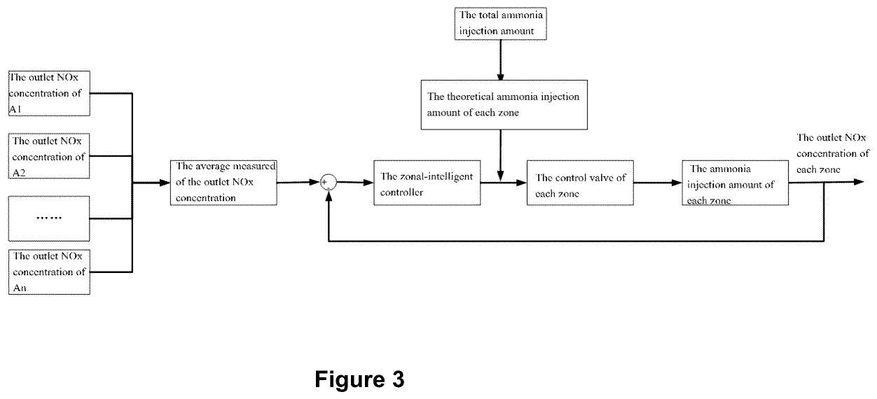

As shown in FIG. 3, specifically, the zonal control method for denitrification ammonia injection adopts the zonal-intelligent controller, the input of the zonal-intelligent controller is the deviation between the average value of the outlet NOx concentration measurement of each zone and the measured value of the outlet NOx concentration of each zone, and the output of the zonal-intelligent controller is the calculated value of the ammonia injection volume of each zone. According to the calculated value of the ammonia injection volume of each zone and the amount of theoretically required ammonia injection of each zone, the opening degree of the control valve of each zone is obtained, the ammonia injection amount of each zone is controlled, and the outlet NOx concentration value of each zone is further controlled.

Specifically, the zonal-intelligent controller can adopt PID control or model predictive control, and its parameters are optimized by genetic algorithm.

Specifically, the average value of the outlet NOx concentration measurement of each zone is calculated according to formula (1).

$$Ave\_NOx = ( A1\_NOx + A2\_NOx + … + An\_NOx ) / n ; \qquad Formula ( 1 )$$

where A1_NOx, A2_NOx, and An_NOx are the outlet NOx concentration values of the 1st zone, the 2nd zone, and the nth zone, respectively, n is the number of zones, which is usually divided into 4-6 zones.

Specifically, the theoretical ammonia injection amount required for each zone is mainly obtained based on the total ammonia injection volume and the weight of each zone. The weight of each zone is mainly obtained based on the proportion of the outlet NOx concentration of each zone, which is specifically obtained according to formula (2).

$${λ}_{i} = \frac{Ai\_NOx}{A1\_NOx + A2\_NOx + … + An\_NOx} ; \qquad Formula ( 2 )$$

where Ai_NOx is the outlet NOx concentration of the ith zone, and λᵢ is the weight of the ith zone.

The amount of theoretically required ammonia injection for the ith zone is calculated according to formula (3):

$$Ai\_NH3 = {λ}_{i} ⋆ Total\_NH3 ; \qquad Formula ( 3 )$$

where Ai_NH3 is the amount of theoretically required ammonia injection in the ith zone, and Total_NH3 is the total ammonia injection amount.

Specifically, in step 300, different incoming coals are determined according to the parameters of the ash content, volatile matter content, moisture content, and calorific value parameter of the incoming coals. Under different incoming coals, the parameters of the inlet NOx concentration of the denitrification reactor, the flue gas volume, the main-intelligent controller for the total amount, the sub-intelligent controller for the total amount, and the zonal-intelligent controller are different. According to different incoming coals, the parameters of the above-mentioned models are established, and a parameter library for different incoming coals is constructed. In the subsequent control process, according to the opacity of incoming coal, different model parameters are selected from the parameter library for incoming coal.

The present disclosure overcomes the problems of delayed measurement of the inlet NOx concentration of the denitrification reactor, inaccurate measurement of flue gas volume, uneven ammonia injection, etc., and can achieve emission of the outlet NOx concentration of the denitrification reactor meeting the standards under the condition of minimum ammonia injection, which is of great significance for reducing pollutant emissions and costs in thermal power plants.

The inlet NOx concentration of the SCR reactor prediction method and flue gas volume calculation method based on the BP neural network algorithm of the present disclosure can predict the inlet NOx concentration of the SCR reactor and flue gas volume in advance, and solve the problems of large lag and inaccurate measurement existing in the measurement of built-in instruments and equipment.

The present disclosure is based on the total ammonia injection control method controlled by a two-stage intelligent controller. During the establishment of the intelligent controller, the differences in data characteristics under various loads are comprehensively considered, and the genetic algorithm is used to optimize the parameters of different loads to obtain optimal controller parameters.

The zonal control method based on the intelligent controller of the present disclosure can effectively control the outlet NOx concentration of each zone, so that the outlet NOx concentration of each zone is evenly distributed, which is more conducive to total amount control.

The present disclosure takes into account that the characteristics of the incoming coal have a great influence on the inlet NOx concentration and flue gas volume of the denitrification reactor. During the modeling process, controller parameter values under different coal quality characteristics are also constructed. The system can adjust different parameters according to the different incoming coal to achieve better control effect.

The present disclosure can stabilize the outlet NOx concentration near the set value, the whole process is simple to operate and quick to adjust, and the outlet NOx emission is controlled to meet the standard with the optimal ammonia injection amount.

Finally, it should be noted that the above embodiments are only used to illustrate the technical solutions of the present disclosure, rather than to limit it. Although the present disclosure has been described in detail with reference to the aforementioned embodiments, those skilled in the art should understand that they can still modify the technical solutions described in the aforementioned embodiments, or replace some or all of the technical features therein with equivalents. However, these modifications or replacements do not cause the essence of the corresponding technical solutions to deviate from the scope of the technical solutions of the embodiments of the present disclosure.

1. A method for optimizing ammonia injection control of a denitrification system in thermal power plants considering the characteristics of incoming coal, comprising a total control method for the amount of denitrification ammonia injection, a zonal control method for the amount of denitrification ammonia injection, and a construction of total amount control and zonal control parameters under different coal quality characteristics,
wherein the method comprises the following steps:
step 100, by means of the total control method for the amount of denitrification ammonia injection, mainly adopting a two-stage intelligent controller for control, wherein a main-intelligent controller controls the total amount of the ammonia injection based on the deviation value of the outlet NOx concentration, as well as the feedforward values of the denitrification inlet NOx concentration and the flue gas volume, and a sub-intelligent controller for the total amount controls the opening degree of the total valve according to the deviation value of the amount of ammonia injection;
step 200, by means of the zonal control method for denitrification ammonia injection volume, taking the deviation value of the outlet NOx concentration of each zone and the total ammonia injection volume as constraint condition to obtain the opening degree of the regulating valve in each zone; and
step 300, by means of the construction of the parameters for total amount control and zonal control under different coal quality characteristics, mainly based on the differences in the ash content, volatile matter content, moisture content, and calorific value of the coal entering the thermal power plants, establishing the parameter values of each value of controllers.

2. The method for optimizing ammonia injection control of a denitrification system in thermal power plants considering the characteristics of incoming coal according to claim 1, wherein the input of the main-intelligent controller for the total amount is the deviation between the set value of the outlet NOx concentration and the average value of the measured outlet NOx concentration of each zone; the output of the main-intelligent controller for the total amount is mainly the calculated value of the ammonia injection volume;
the input of the sub-intelligent controller for the total amount is the calculated value of the ammonia injection volume and theoretical ammonia injection volume; the output of the sub-intelligent controller for the total amount is the total control valve of the denitrification reactor, the total amount of ammonia injection is controlled by the opening degree of the total control valve, thereby controlling the outlet NOx concentration value of the denitrification reactor; and
the main-intelligent controller for the total amount and the sub-intelligent controller for the total amount adopt PID control or model predictive control, and their parameters are obtained by optimization using genetic algorithm.

3. The method for optimizing ammonia injection control of a denitrification system in thermal power plants considering the characteristics of incoming coal according to claim 1, wherein the zonal control method for denitrification ammonia injection adopts a zonal-intelligent controller, the input of the zonal-intelligent controller is the deviation between the average value of the outlet NOx concentration measurement of each zone and the measured value of the outlet NOx concentration of each zone, and the output of the zonal-intelligent controller is the calculated value of the ammonia injection volume of each zone; the opening degree of the control valve of each zone is obtained according to the calculated value of the ammonia injection volume of each zone and the amount of theoretically required ammonia injection of each zone, so as to control the ammonia injection volume of each zone, and further control the outlet NOx concentration value of each zone; and
the zonal-intelligent controller adopts PID control or model predictive control, and its parameters are optimized by genetic algorithm.

4. The method for optimizing ammonia injection control of a denitrification system in thermal power plants considering the characteristics of incoming coal according to claim 1, wherein in step 300, different incoming coals are determined according to the parameters of ash content, volatile matter content, moisture content, and calorific value of the incoming coals, under different incoming coals, the parameters of the inlet NOx concentration of the denitrification reactor, the flue gas volume, the main-intelligent controller for the total amount, the sub-intelligent controller for the total amount, and the zonal-intelligent controller are different; according to different incoming coals, the parameters of the above-mentioned models are established, and a parameter library for different incoming coals is constructed; in the subsequent control process, according to the opacity of incoming coal, different model parameters are selected from the parameter library for incoming coal.

5. The method for optimizing ammonia injection control of a denitrification system in thermal power plants considering the characteristics of incoming coal according to claim 2, wherein the theoretical ammonia injection volume is obtained based on the product of the SCR inlet NOx concentration value, the flue gas volume and the ammonia nitrogen molar ratio.

6. The method for optimizing ammonia injection control of a denitrification system in thermal power plants considering the characteristics of incoming coal according to claim 2, wherein the SCR inlet NOx concentration is predicted based on a BP neural network algorithm; the influencing factors related to the inlet NOx concentration are analyzed according to the generation mechanism of the SCR inlet NOx concentration, comprising unit load, total air volume, total coal volume, and primary air volume; these parameters are used as the input parameters of the BP neural network, and the output is the SCR inlet NOx concentration.

7. The method for optimizing ammonia injection control of a denitrification system in thermal power plants considering the characteristics of incoming coal according to claim 2, wherein the flue gas volume is predicted according to the BP neural network algorithm; the influencing factors related to the flue gas volume are analyzed according to the flue gas generation mechanism, comprising unit load, total air volume, and oxygen content, and these parameters are used as input parameters of the BP neural network; and the output is the flue gas volume.

8. The method for optimizing ammonia injection control of a denitrification system in thermal power plants considering the characteristics of incoming coal according to claim 2, wherein the BP neural network adopts a three-layer structure consisting of an input layer, a hidden layer and an output layer, and its parameters include the weights and thresholds between the input layer and the hidden layer, as well as the weights and threshold parameters between the hidden layer and the output layer; these parameters are mainly obtained by continuously optimizing the error function between the predicted values and the measured values.

9. The method for optimizing ammonia injection control of a denitrification system in thermal power plants considering the characteristics of incoming coal according to claim 3, wherein the average value of the outlet NOx concentration measurement of each zone is calculated according to formula (1):
$$Ave\_NOx = ( A1\_NOx + A2\_NOx + … + An\_NOx ) / n ; \qquad ( Formula 1 )$$
where A1_NOx, A2_NOx, and An_NOx are the outlet NOx concentration values of the 1st zone, the 2nd zone, and the nth zone, respectively, n is the number of zones.

10. The method for optimizing ammonia injection control of a denitrification system of thermal power plants considering the characteristics of incoming coal according to claim 3, wherein the theoretical ammonia injection volume required for each zone is mainly obtained based on the total ammonia injection volume and the weight of each zone, the weight of each zone is mainly obtained based on the proportion of the outlet NOx concentration of each zone, which is specifically obtained according to formula (2):
$${λ}_{i} = \frac{Ai\_NOx}{A1\_NOx + A2\_NOx + … + An\_NOx} ; \qquad ( Formula 2 )$$
where Ai_NOx is the outlet NOx concentration of the i-th zone, and λᵢ is the weight of the ith zone;
the theoretically required ammonia injection volume for the ith zone is calculated according to formula (3):
$$Ai\_NH3 = {λ}_{i} ⋆ Total\_NH3 ; \qquad ( Formula 3 )$$
where Ai_NH3 is the theoretically required ammonia injection volume in the ith zone, and total_NH3 is the total ammonia injection volume.
